(19) United States
(12) Patent Application Publication
(10) Pub. No.: US 2003/0010602 A1
(43) Pub. Date: Jan. 16, 2003

(54) Conveyor comprising article carrying plates having at least two parts

(76) Inventor: Navam Jagan, Brossard (CA)

Correspondence Address: LESPERANCE & MARTINEAU, 1440 WEST, STE-CATHERINE ROOM 700, MONTREAL, QC, H3G1R8, CA

(21) Appl. No.: 10/192,880

(22) Filed: Jul. 5, 2002

Related U.S. Application Data
(60) Provisional application No. 60/304,782, filed on Jul. 13, 2001.

(51) Int. Cl. B65G 29/00

(52) U.S. Cl. 198/469.1

(57) ABSTRACT

An endless chain running through a tubular conveyor sleeve, for conveying articles from an inlet to an outlet, the endless chain being tensioned between two sprocket wheels. The endless chain comprises chain links, some of them having transportation discs attached thereto. The transportation discs comprise at least two portions attached together around and against the corresponding chain links.

This patent application claims priority of co-pending U.S. provisional patent application No. 60/304,782 filed on Jul. 13, 2001.

### FIELD OF THE INVENTION

The present invention relates to conveying mechanisms, and particularly refers to a conveyor of the type comprising article-carrying plates having at least two parts attached together, these plates pushing articles inside a tubular sleeve from an inlet port to an outlet port.

### BACKGROUND OF THE INVENTION

It is known to use conveyors to convey articles from an inlet opening to an outlet opening. These conveyors typically have a tubular sleeve in which runs an endless or continuous chain, with article-carrying plates being provided on the chain links at regular intervals to carry articles. Indeed, the plates have a diameter which is substantially equal to the diameter of the conveyor sleeve, and thus an article will be axially pushed along the sleeve by the rearwardly adjacent plate of the chain. Thus, articles are loaded in the conveyor between successive plates, and can be carried along a sleeve by the plates. The sleeve may be elbowed and may follow an irregular, non-horizontal pattern, since the chain links form universal joints with one another and thus allow the chain to articulately move within the conveyor sleeve.

The problem associated with this type of conventional conveyors is that the plates are attached to the chain links in a very complex manner.

### SUMMARY OF THE INVENTION

The present invention relates to an elongated carrying member for conveying articles inside a sleeve, said carrying member comprising:

a filiform carrier destined to extend inside the sleeve and to be movable therein;

a number of transportation plates shaped and sized for fitting inside the sleeve and comprising at least two plate portions; and

attachment means attaching said at least two plate portions to one another and to said filiform carrier.

In one embodiment, said attachment means are releasable whereby each said transportation plate is releasably fixedly attached to said filiform carrier.

In one embodiment, said plate portions are attached to one another with at least one bolt.

In one embodiment, said filiform carrier is a chain comprising a number of successively interlocked chain links.

In one embodiment, each transportation plate is carried by a single corresponding chain link.

In one embodiment, every chain link carrying a corresponding said transportation plate comprises at least one retaining member integrally attached thereto, and recesses are formed within each said plate portion, said retaining members being embedded within said recesses, to prevent longitudinal displacement of said transportation plate attached to said chain link along said chain under article-borne loads.

In one embodiment, each said transportation plate comprises at least one structurally reinforcing bracing rib integrally formed therein.

In one embodiment, each said transportation plate comprises two plate portions.

In one embodiment, said two plate portions each comprises transverse bearing recesses cooperating with corresponding bearing recesses of the other said plate portion to form through-bores to accommodate said chain link that passes through said through-bores when said plate portions are attached together.

In one embodiment, said two plate portions are adjoined by connecting surfaces having complementary transverse abutment shoulders transversally reinforcing the engagement between said plate portions, said connecting surfaces having a complementary shape for positive inter-connection therebetween to form a single said transportation plate when said plate portions are attached to one another with said attachment means.

The present invention also relates to a conveyor, comprising a sleeve having an inlet port and an outlet port, said conveyor comprising an elongated carrying member comprising an elongated filiform carrier longitudinally extending inside said sleeve and a number of transportation plates attached to said filiform carrier, said transportation plates being shaped and sized to fit inside said sleeve, each said transportation plate comprising at least two plate portions fixedly attached to one another around and against said filiform carrier whereby said transportation plate is attached to said filiform carrier, said conveyor further comprising a powered carrier-driving means capable of moving said filiform carrier inside said sleeve for conveying articles inside said sleeve with said transportation plates between said inlet and outlet ports with said transportation plates attached to said filiform carrier.

In one embodiment, said filiform carrier is a chain, said chain forms a closed loop and is tensioned between a first and a second sprocket wheels forming said carrier-driving means, said first wheel being idle, said second wheel being power-driven into rotation by a driving station, said second wheel actuating said chain.

In one embodiment, said sleeve is cylindrically shaped, wherein said transportation plates are discs, the diameter of said discs is substantially equal to the inside diameter of said sleeve.

The present invention also relates to a transportation plate destined to be attached fixedly onto a filiform carrier extending inside a tubular conveyor sleeve, said plate being destined to push articles inside the sleeve from an inlet to an outlet of a conveyor by being carried by the filiform carrier, said transportation plate being shaped and sized for fitting inside the sleeve and said transportation plate comprising at least two plate portions destined to be fixedly attached to the filiform carrier; said plate portions of each said transportation plates being adjoined by connecting surfaces having complementary transverse abutment shoulders transversally reinforcing the engagement between said plate portions, said connecting surfaces having a complementary shape for positive inter-connection therebetween to form a single said transportation plate when said portions are attached to one another.

### DESCRIPTION OF THE DRAWINGS

In the annexed drawings:

FIG. 1 is a schematic top plan view of a conveyor equipped with an endless chain according to one embodiment of the invention, with the tubular sleeve being partly removed for showing the endless chain therein;

FIG. 2 is a schematic side elevation of the chain conveyor of FIG. 1 further showing part of an inlet port overlying the endless chain;

FIGS. 3 and 4 are perspective views, at an enlarged scale, of a portion of the endless chain of the conveyor of FIG. 1, further showing an exploded and an assembled representation respectively of a transportation disc according to a first embodiment;

FIG. 5 is a plan view of a chain link with retaining members integrally fixed thereto to carry a corresponding transportation disc;

FIG. 6 is an enlarged side elevation of a portion of the endless chain conveyor of FIG. 1;

FIG. 7 is a perspective view of a half-disc of the transportation disc of FIG. 3;

FIG. 8 is a front elevation of the transportation disc of FIG. 3;

FIG. 9 is a cross-sectional view taken along line IX-IX of FIG. 8.

FIGS. 10 and 11 are front and rear perspective views respectively of the transportation disc of FIG. 3; and

FIGS. 12 and 13 are perspective views second and third embodiments respectively of a transportation disc according to the present invention.

### DETAILED DESCRIPTION OF THE EMBODIMENTS

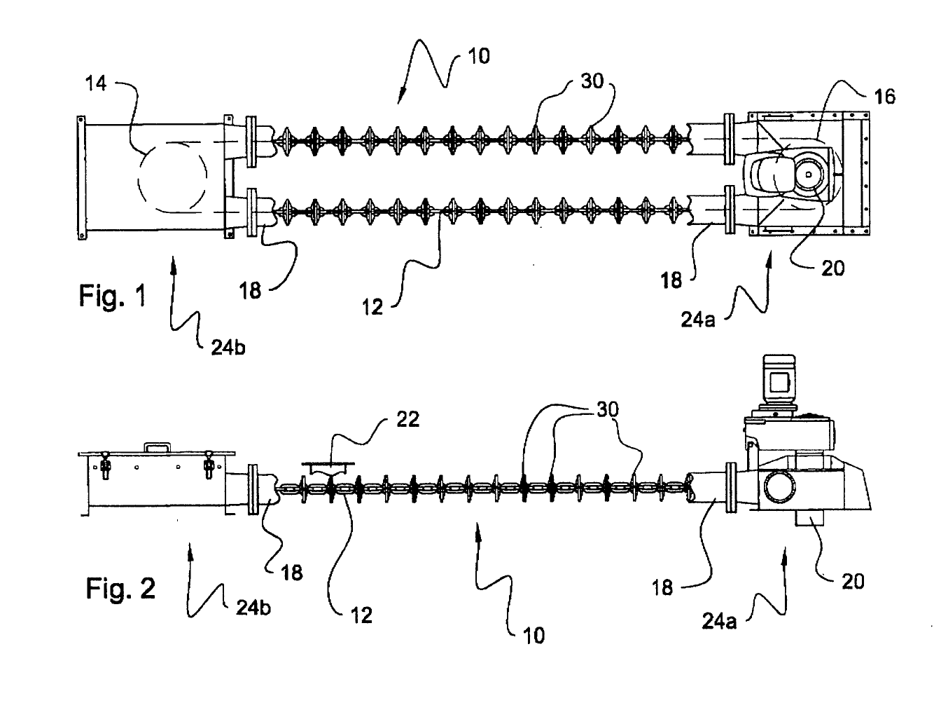

FIGS. 1 and 2 schematically show a conveyor 10 of the invention including a tubular sleeve 18 having an inlet port 22, an outlet port 20 and a drive station 24a. Conveyor 10 farther comprises a pair of spaced-apart sprocket wheels 14 and 16 between which is tensioned an endless chain 12 forming a closed loop according to one embodiment of the invention. Wheel 16 is power-driven into rotation by drive station 24a, while wheel 14 is idle. Sprocket wheel 14 is located inside a tensioning station 24b. Wheel 16 supports and actuates chain 12 while wheel 14 supports it; both wheels securely hold chain 12, for example by means of teeth peripherally provided about wheels 14 and 16 that engage the chain links. Articles to be conveyed are inserted into sleeve 18 through inlet port 22, and are conveyed by endless chain 12 provided with spaced-apart article-carrying plates 30 (also referenced to as transportation plates 30), to outlet port 20. Conveyor 10 is shown in FIGS. 1 and 2 as being planar and horizontal, but it is understood that sleeve 18 could be shaped otherwise. For example, if driving station 24a and tensioning station 24b do not have the same vertical position, sleeve 18 could have an elbowed geometry, hence providing chain 22 with a path for linking stations 24a and 24b together.

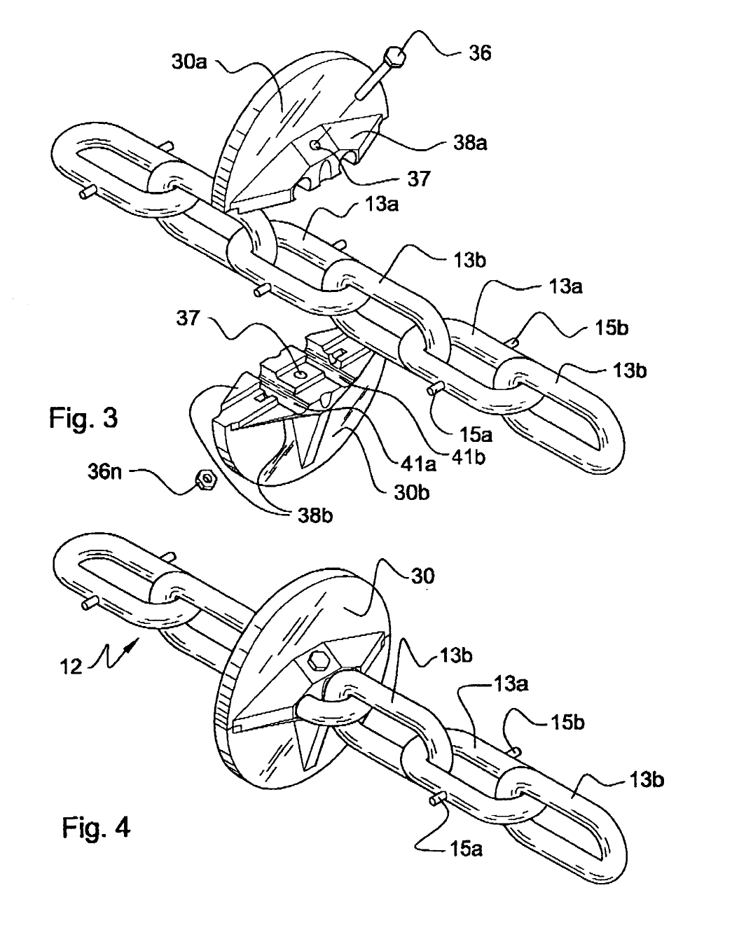

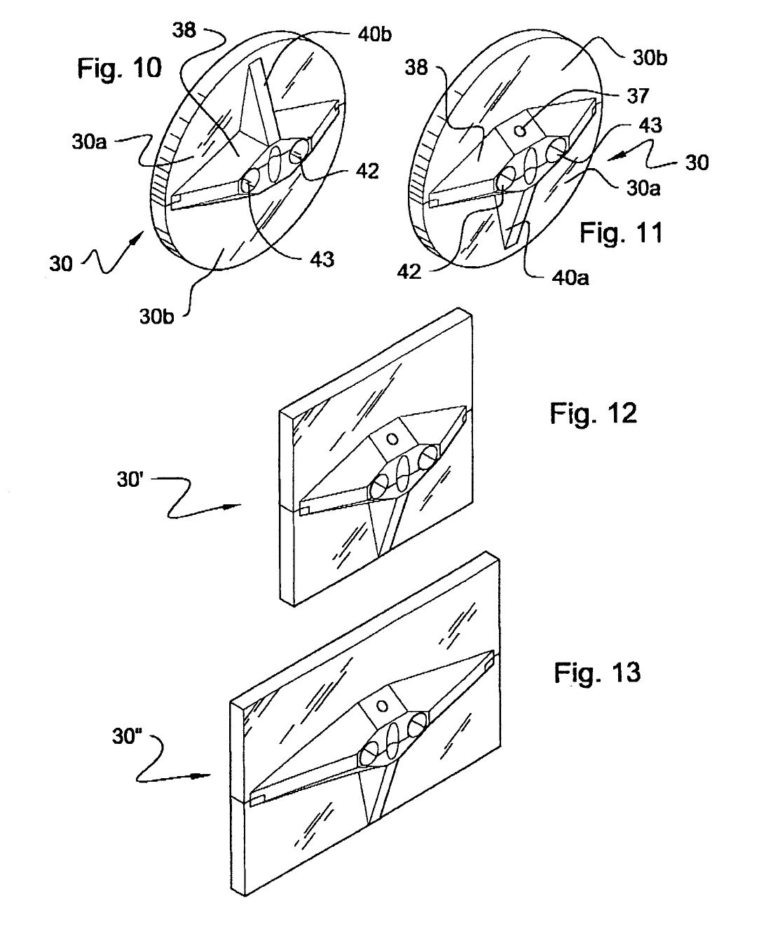

FIGS. 3, 4 and 6 show that endless chain 12 comprises a number of chain links 13a, 13b which can be made of metal for example, and interlocked with one another in a conventional manner. Every other chain link 13a can be provided with an article-carrying plate 30, made of plastic for example, and attached thereto in a manner described hereinafter. Transportation plates 30, according to a first embodiment thereof shown in FIGS. 4, 10 and 11, have a generally cylindrical shape, with a radially circular outer surface, to slide along the complementary tubular inner surface of sleeve 18, and will from now on be referred to as a transportation discs 30. The other chain links 13b, do not support discs 30. Each disc 30 has a diameter which is substantially equal to the inner diameter of sleeve 18, so that articles inserted into sleeve 18 be carried by the rearwardly adjacent disc 30 without being allowed to slide between the periphery of discs 30 and the inner surface of sleeve 18.

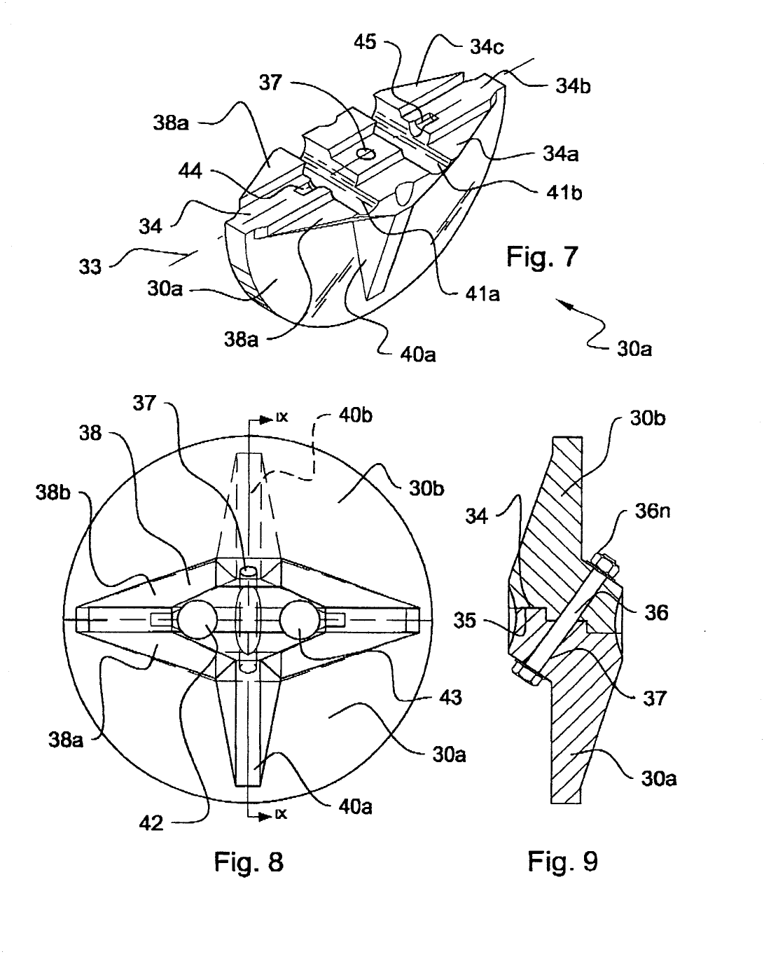

Transportation discs 30, as shown in FIGS. 3, 4 and 6, are fastened to chain link 13a of conveyor chain 12. Two identical half-discs 30a and 30b form a single transportation disc 30. A surface of division extending through the center of transportation disc 30, and along the diameter marked as 33 in FIG. 7, divides disc 30, and adjoins stair-shaped connecting surface 34 of half-disc 30a and connecting surface 35 of half-disc 30b. In one embodiment, stair-shaped connecting surfaces 34 and 35 each have three steps. Half-disc 30a comprises a middle step 34b extending longitudinally along diameter 33, one other step 34a is recessed within half-disc 30a on one side of middle step 34b, and another step 34c is extruded on the other side of middle step 34b. The other identical half-disc 30b is inversely positioned relatively to half-disc 30a, and comprises the same three steps, marked as 35a, 35b and 35c, respectively corresponding to steps 34a, 34b and 34c of half-disc 30a. When half-discs 30a and 30b are assembled, step 34a is juxtaposed to step 35c, step 34b is juxtaposed to step 35b, and step 34c is juxtaposed to step 35a; surfaces 34 and 35 can therefore be adjoined in order for the two half-discs 30a and 30b to interlock in a snug fit. As can be seen in FIGS. 7 and 8, connecting surfaces 34 and 35 of half-discs 30a and 30b extend diametrically through disc 30. Steps 34a, 34b, 34c, 35a, 35b and 35c hence form complementary abutment shoulders transversally reinforcing the engagement between the two half-discs 30a and 30b.

Half-discs 30a and 30b are joined to form transportation disc 30 by a centrally positioned bolt 36 secured by a nut 36n. As can be seen in FIGS. 8 and 9, a bore 37 for bolt 36 extends diagonally through the two half-discs 30a and 30b. Each half of the transportation disc 30a and 30b has diametrical bracing ribs 38a and 38b on both sides thereof that extend parallel to diameter 33. Bracing ribs 38a and 38b on each half-disc 30a and 30b, form slanted contact surfaces for the head of bolt 36 and nut 36n securing bolt 36 on opposites sides of disc 30. When half-discs 30a and 30b are attached together, bracing rib 38a of half-disc 30a and bracing rib 38b of half-disc 30b form a diametrical bracing rib 38, and bracing rib 38b of half-disc 30a and bracing rib 38a of half-disc 30b form another diametrical bracing rib 38, positioned on the opposite side of disc 30 relative to the previously mentioned diametrical bracing rib 38.

Furthermore, half-disc 30a has on one side been provided with a radial bracing rib 40a that extends radially relative to disc 30 and perpendicularly relative to diametrical bracing rib 38a. Half-disc 30b has a corresponding radial bracing rib 40b.

Diametrical bracing ribs 38a, 38b and radial bracing ribs 40a, 40b structurally reinforce disc 30, especially in the area of interconnection between disc 30 and its corresponding chain link 13a.

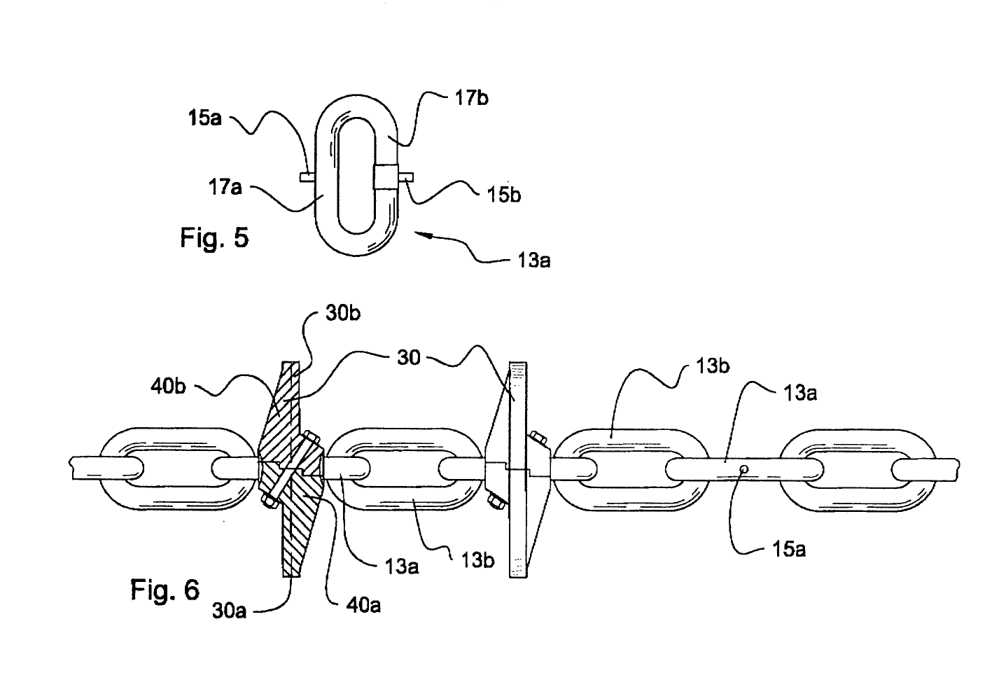

Each connecting surface 34, 35, for example connecting surface 34 of half-disc 30a, comprises bearing recesses 41a and 41b in the shape of half shells on both sides of bolt bore 37 to accommodate chain link 13a. Bearing recesses 41a and 41b extend transversally through half-disc 30a. Bearing recesses 41a and 41b on both transportation half-discs 30a and 30b complement each other to form through-bores 42 and 43 extending transversally through disc 30, as shown in FIGS. 7 and 8, in order to accommodate the longitudinal bars of chain link 13a, marked as 17a and 17b in FIG. 5.

Chain link 13a comprises two retaining members 15a and 15b integrally fixed to its longitudinal bars 17a and 17b. Recesses 44 and 45 provided on each connecting surface 34 and 35 of half-discs 30a and 30b, complement each other to form cylindrical recesses when half-discs 30a and 30b are assembled, the contour of which is complementary to the two retaining members 15a and 15b, and serve the purpose of housing retaining members 15a and 15b. When half-discs 30a and 30b are assembled, retaining members 15a and 15b are securely embedded and positioned within respective recesses 44 and 45 of transportation disc 30, preventing sliding motion of disc 30 relative to chain link 13a, especially under important loads.

In one embodiment, retaining members 15a and 15b are cylindrical pins although other shapes are envisioned. In an alternative embodiment, there can be more or less than two retaining members.

The mounting of a disc 30 onto chain 12 is accomplished as follows: half-discs 30a and 30b are positioned on either side of a corresponding chain link 13a with the connecting surfaces 34, 35 being adjoined as described hereinabove. The chain link arms 17a, 17b are seated in recesses 41a, 41b and the chain link retaining members 15a, 15b are seated and embedded in recesses 44, 45. Afterwards, bolt 36 is inserted in bore 37 extending through both half-discs 30a, 30b and is secured with nut 36n. Disc 30 is thus securely and removably attached to its corresponding chain link 13a. Replacement and installation are conceivably easy, since bolt 36 is removable.

In one embodiment, both half-discs 30a and 30b are made of impact-resistant plastic and can be easily produced as formed parts by means of extrusion or injection molding.

The materials envisioned for disc 30 include Teflon™, nylatron, fiber glass, UHMW, plastic, polymers, rubber, or any other suitable plastic or non-plastic material.

It has been shown that discs 30 are installed at regular intervals, on every other chain link 13a, but it is understood that discs 30 could be installed at any regular or irregular interval on chain 12. Also, discs 30 have been shown to be cylindrical, but they could be replaced by transportation plates shaped and sized to correspond to the inner configuration of the conveyor sleeve 18. Transportation plates 30′ and 30″ represented in FIGS. 12 and 13 are shaped to fit inside a square and a rectangular tubular sleeve respectively, and could be used without departing from the scope of the present invention.

According to one embodiment of the invention, the discs could include more than two disc portions. For example, disc 30 could comprise four distinct parts which are assembled on a corresponding chain link, to be attached thereto with suitable attachment means, for example a pair of bolts.

According to another embodiment of the invention, the at least two disc parts which are assembled to form a transportation disc, are fixedly attached to one another by any suitable fixing means for example glue, one or more bolts, screws, a snap fit between the disc parts, or any other suitable attachment means.

Alternatively, endless chain 12 could be replaced by any kind of filiform carrier for the transportation plates. In one embodiment, chain 12 could be replaced by a rod carrying the plates along sleeve 18 in a back and forth motion, hence conveying articles from the inlet of the conveyor to the outlet thereof. The filiform carrier would hence be actuated by suitable powered carrier-driving means. In another embodiment, chain 12 could be replaced with an endless belt. According to one embodiment, any suitable powered carrier-driving means capable of moving the filiform carrier inside the sleeve could be used instead of an idle wheel and a power-driven wheel. For example, if the filiform carrier is a rod capable of a reciprocating motion between an inlet and a outlet opening in a linear sleeve, with the transportation plates fixed to the rod, the powered carrier-driving means could be a hydraulic cylinder linked to said rod.

The present invention also relates to a chain for conveying articles inside a sleeve, the chain comprising a number of successively interlocked chain links carrying a number of spaced-apart discs that are attached to the chain. The discs are shaped and sized to fit inside the sleeve. Each disc is mounted to a corresponding disc-carrying chain link which comprises disc retaining members, for example pins, that are attached to the disc-carrying chain link, for preventing axial displacement of the disc along the chain under article-borne loads. The disc comprises two portions which may be assembled together on a corresponding chain link by suitable attachment means, for example a bolt, for fixing the disc to the corresponding chain link. The disc portions have complementary engagement surfaces, which allow a stable engagement of each disc portion with the other. In one embodiment, additional steps are provided on the connecting surfaces of each disc portion for enhanced stability of the inter-engaging disc portions.

Any other modification to the present invention, which does not deviate from the scope thereof, is considered to be included therein.

1. An elongated carrying member for conveying articles inside a sleeve, said carrying member comprising:
a filiform carrier destined to extend inside the sleeve and to be movable therein;
a number of transportation plates shaped and sized for fitting inside the sleeve and comprising at least two plate portions; and
attachment means attaching said at least two plate portions to one another and to said filiform carrier.

2. A carrying member as defined in claim 1, wherein said attachment means are releasable whereby each said transportation plate is releasably fixedly attached to said filiform carrier.

3. A carrying member as defined in claim 1, wherein said plate portions are attached to one another with at least one bolt.

4. A carrying member as defined in claim 1, wherein said filiform carrier is a chain comprising a number of successively interlocked chain links.

5. A carrying member as defined in claim 4, wherein each transportation plate is carried by a single corresponding chain link.

6. A carrying member as defined in claim 5, wherein every chain link carrying a corresponding said transportation plate comprises at least one retaining member integrally attached thereto, and wherein recesses are formed within each said plate portion, said retaining members being embedded within said recesses, to prevent longitudinal displacement of said transportation plate attached to said chain link along said chain under article-borne loads.

7. A carrying member as defined in claim 4, wherein each said transportation plate comprises at least one structurally reinforcing bracing rib integrally formed therein.

8. A carrying member as defined in claim 5, wherein each said transportation plate comprises two plate portions.

9. A carrying member as defined in claim 8, wherein said two plate portions each comprises transverse bearing recesses cooperating with corresponding bearing recesses of the other said plate portion to form through-bores to accommodate said chain link that passes through said through-bores when said plate portions are attached together.

10. A carrying member as defined in claim 8, wherein said two plate portions are adjoined by connecting surfaces having complementary transverse abutment shoulders transversally reinforcing the engagement between said plate portions, said connecting surfaces having a complementary shape for positive inter-connection therebetween to form a single said transportation plate when said plate portions are attached to one another with said attachment means.

11. A conveyor, comprising a sleeve having an inlet port and an outlet port, said conveyor comprising an elongated carrying member comprising an elongated filiform carrier longitudinally extending inside said sleeve and a number of transportation plates attached to said filiform carrier, said transportation plates being shaped and sized to fit inside said sleeve, each said transportation plate comprising at least two plate portions fixedly attached to one another around and against said filiform carrier whereby said transportation plate is attached to said filiform carrier, said conveyor further comprising a powered carrier-driving means capable of moving said filiform carrier inside said sleeve for conveying articles inside said sleeve with said transportation plates between said inlet and outlet ports with said transportation plates attached to said filiform carrier.

12. A conveyor as defined in claim 11, wherein each said transportation plate comprises two plate portions.

13. A carrying member as defined in claim 12, wherein said two plate portions are adjoined by connecting surfaces having complementary transverse abutment shoulders transversally reinforcing the engagement between said plate portions, said connecting surfaces having a complementary shape for positive inter-connection therebetween to form a single said transportation plate when said plate portions are attached to one another with said attachment means.

14. A conveyor as defined in claim 11, wherein said filiform carrier is a chain comprising a number of successively interlocked chain links.

15. A conveyor as defined in claim 14, wherein said chain forms a closed loop and wherein said chain is tensioned between a first and a second sprocket wheels forming said carrier-driving means, said first wheel being idle, said second wheel being power-driven into rotation by a driving station, said second wheel actuating said chain.

16. A conveyor as defined in claim 14, wherein each transportation plate is carried by a single corresponding chain link.

17. A conveyor as defined in claim 16, wherein said two plate portions each comprises transverse bearing recesses cooperating with corresponding bearing recesses of the other said plate portion to form through-bores to accommodate said chain link that passes through said through-bores when said plate portions are attached together.

18. A conveyor as defined in claim 14, wherein every chain link carrying a corresponding transportation plate comprises at least one retaining member integrally attached thereto, and wherein recesses are formed within each said plate portion, said retaining members being embedded within said recesses, to prevent longitudinal displacement of said transportation plate attached to said chain link along said chain under article-borne loads.

19. A conveyor as defined in claim 11, wherein said sleeve is cylindrically shaped, wherein said transportation plates are discs, and wherein the diameter of said discs is substantially equal to the inside diameter of said sleeve.

20. A transportation plate destined to be attached fixedly onto a filiform carrier extending inside a tubular conveyor sleeve, said plate being destined to push articles inside the sleeve from an inlet to an outlet of a conveyor by being carried by the filiform carrier, said transportation plate being shaped and sized for fitting inside the sleeve and said transportation plate comprising at least two plate portions destined to be fixedly attached to the filiform carrier; said plate portions of each said transportation plates being adjoined by connecting surfaces having complementary transverse abutment shoulders transversally reinforcing the engagement between said plate portions, said connecting surfaces having a complementary shape for positive inter-connection therebetween to form a single said transportation plate when said portions are attached to one another.
